(19) United States
(12) Patent Application Publication
(10) Pub. No.: US 2025/0283199 A1
(43) Pub. Date: Sep. 11, 2025

(54) HIGH TEMPERATURE DISSOLVABLE ALUMINUM FOR OIL AND GAS APPLICATIONS

(71) Applicants: CNPC USA CORP., Houston, TX (US); BEIJING HUAMEI, INC., Beijing (CN); CHINA NATIONAL PETROLEUM CORPORATION, Beijing (CN)

(72) Inventors: Timothy Ryan DUNNE, Pearland, TX (US); Lei ZHAO, Houston, TX (US); Jiaxiang (Jason) REN, Houston, TX (US); Peng CHENG, Houston, TX (US); Huailiang LIU, Beijing (CN)

(21) Appl. No.: 18/599,865

(22) Filed: Mar. 8, 2024

(51) Int. Cl. C22C 21/00; C09K 8/42

(52) U.S. Cl. CPC C22C 21/00; C09K 8/426

(57) ABSTRACT

A dissolvable aluminum alloy can be used for components of a downhole tool. The dissolvable aluminum alloy can be dissolved completely and controlled at a dissolving rate so as to be compatible with downhole operations, including hydraulic fracturing operations. The alloy includes from about 0.01 wt % to about 1.5 wt % gallium; from about 0.01 wt % to about 1.5 wt % indium; from about 0.01 wt % to about 1.5 wt % bismuth; and the balance of substantial aluminum so as to be dissolvable in KCl at about 2.1% by weight and about 93° C. with a dissolving rate in a range of from about 10 to about 100 mg/cm2/hr, yield strength in a range of from about 25 to about 45 ksi, ultimate tensile strength in a range of from about 35 to about 60 ksi, and elongation in a range of from about 4 to about 15% at room temperature.

### BACKGROUND OF THE INVENTION

### Field of the Invention

The present invention relates to a material composition in the oil and gas industry. More particularly, the present invention relates to dissolvable metal alloys to form components of downhole tools. Even more particularly, the present invention relates to a high temperature dissolvable aluminum for oil and gas applications.

### Background

Downhole tools are commonly used in oil and gas production. A borehole is drilled through a hydrocarbon bearing formation, and downhole tools, such as plugs and sleeves are positioned along and within the borehole. The plugs close and open portions of the borehole so that zones may be selectively isolated. A plug can include at least one dissolvable metallic component. As an assembly, the plug must hold a pressure differential around 7.5 ksi. A sleeve opens and closes to make the fluid connection between the borehole and the formation. The downhole tools work to isolate and connect the zone for various operations to prepare and produce the hydrocarbons from the formation. When the operations are complete in the zone, components of the downhole tool or even the entire downhole tool may require removal. For example, a dissolvable frac ball set in a plug to trigger a seal may be removed by injecting a solvent targeted to the dissolvable frac ball so that the seal is removed. After the fracturing operation, the components dissolve in the wellbore fluid, typically a potassium chloride brine. Alternatively, the entire plug may be removed.

Dissolvable alloys were developed for the manufacture of downhole tool components in the oil and gas industry. There are mainly two types of metallic dissolvable alloys: magnesium and aluminum-based alloys. These alloys may be cast and mechanically worked in a variety of manners, including but not limited to vertical direct chill casting, vacuum induction melting, and extrusion.

It is an object of the present invention to provide a dissolvable alloy.

It is another object of the present invention to provide a dissolvable aluminum alloy for components of a downhole tool.

These and other objectives and advantages of the present invention will become apparent from a reading of the attached specification.

### BRIEF SUMMARY OF THE INVENTION

Embodiments of the present invention include a dissolvable alloy for components of a downhole tool. The assembly of a downhole tool with a dissolvable metallic component, which comprises a dissolvable alloy, having from about 0.01 wt % to about 1.5 wt % gallium; from about 0.01 wt % to about 1.5 wt % indium; from about 0.01 wt % to about 1.5 wt % bismuth; and the balance of substantial aluminum so as to be dissolvable in KCl at about 2.1% by weight and about 93° C. with a dissolving rate in a range of from about 10 to about 100 mg/cm²/hr, yield strength in a range of from about 25 to about 45 ksi, ultimate tensile strength in a range of from about 35 to about 60 ksi, and elongation in a range of from about 4 to about 15% at room temperature.

Optionally in any embodiment, the dissolvable alloy may comprise about 5.1 wt % to about 6.1 wt % zinc.

Optionally in any embodiment, the dissolvable alloy may comprise about 1.2 wt % to about 2.0 wt % copper.

Optionally in any embodiment. the dissolvable alloy may comprise about 2.1 wt % to about 2.9 wt % magnesium.

Optionally in any embodiment, the dissolvable alloy may comprise about 0.18 wt % to about 2.0 wt % chromium.

Optionally in any embodiment, the dissolvable alloy may comprise from about 0.0 to about 0.2 wt % titanium.

Optionally in any embodiment, the dissolvable alloy may comprise about 0.0 to about 0.4% silicon.

Optionally in any embodiment, the dissolvable alloy may comprise from about 0.0 to about 0.5% iron.

Optionally in any embodiment, the dissolvable alloy may comprise about 0.01-5.0 wt % cerium.

In another embodiment, a dissolvable alloy for components of a downhole tool is disclosed. The dissolvable alloy may comprise from about 0.01 wt % to about 1.5 wt % gallium; from about 5.1 wt % to about 6.1 wt % zinc; from about 1.2 to about 2.0 wt % copper; and the balance of substantial aluminum so as to be dissolvable in KCl at about 2.1% by weight and about 93° C. with a dissolving rate in a range of from about 10 to about 100 mg/cm²/hr, yield strength in a range of from about 25 to about 45 ksi, ultimate tensile strength in a range of from about 35 to about 60 ksi, and elongation in a range of from about 4 to about 15% at room temperature.

Optionally in any embodiment, the dissolvable alloy may comprise from about 0.01 wt % to about 1.5 wt % indium.

Optionally in any embodiment, the dissolvable alloy may comprise from about 0.01 wt % to about 1.5 wt % bismuth.

Optionally in any embodiment, the dissolvable alloy may comprise about 2.1 wt % to about 2.9 wt % magnesium.

Optionally in any embodiment, the dissolvable alloy may comprise from about 0.0 to about 0.2 wt % titanium.

Optionally in any embodiment, the dissolvable alloy may comprise from about 0.01 wt % to about 5.0 wt % cerium.

In further embodiment, a dissolvable alloy for a component of a downhole tool may comprise from about 0.01 wt % to about 1.5 wt % indium; from about 0.01 wt % to about 1.5 wt % bismuth; from about 5.1 wt % to about 6.1 wt % zinc; and the balance of substantial aluminum so as to be dissolvable in KCl at about 2.1% by weight and about 93° C. with a dissolving rate in a range of from about 10 to about 100 mg/cm²/hr, yield strength in a range of from about 25 to about 45 ksi, ultimate tensile strength in a range of from about 35 to about 60 ksi, and elongation in a range of from about 4 to about 15% at room temperature.

Optionally in any embodiment, the dissolvable alloy may comprise from about 1.2 wt % to about 2.0 wt % copper.

Optionally in any embodiment, the dissolvable alloy may comprise from about 2.1 wt % to about 2.9 wt % magnesium.

Optionally in any embodiment, the dissolvable alloy further comprises from about 0.18 wt % to about 2.0 wt % chromium.

Optionally in any embodiment, the dissolvable alloy further comprises from about 0.01 wt % to about 5.0 wt % cerium.

### BRIEF DESCRIPTION OF DRAWINGS

FIG. 1 is a graph illustrating the yield strength, ultimate tensile strength, and elongation of the alloys from the longitudinal direction.

FIG. 2 is a graph illustrating the yield strength, ultimate compression strength, at room temperature and at 140° C. for alloys HSAL #1.

FIG. 3 is a graph illustrating the yield strength, ultimate compression strength, at room temperature and at 140° C. for alloys HSAL #2.

FIG. 4 is a graph illustrating the yield strength, ultimate compression strength, at room temperature and at 140° C. for alloys HTAL #1.

FIG. 5 is a photo illustrating an alloy HSAL #1 after immersion in 120° C. 2.1% KCl after 2 hours.

FIG. 6 is a photo illustrating an alloy HSAL #2 after immersion in 120° C. 2.1% KCl after 2 hours.

FIG. 7 is a photo illustrating an alloy HTAL #1 after immersion in 120° C. 2.1% KCl after 2 hours.

FIG. 8 is a photo illustrating an alloy HTAL #1 after immersion in 150° C. 2.1% KCl after 2 hours.

### DETAILED DESCRIPTION OF THE INVENTION

Before the description of the embodiment, terminology, methodology, systems, and materials are described; it is to be understood that this disclosure is not limited to the particular terminologies, methodologies, systems, and materials described, as these may vary. It is also to be understood that the terminology used in the description is for the purpose of describing the particular versions of embodiments only, and is not intended to limit the scope of embodiments. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”.

Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45%-55%.

Aluminum alloy is an alloy based on aluminum and some other additional elements. It has the following characteristics: low density (about 2.7 g/cm³), which is lower than that of other common metals; about one-third that of steel. It has a great affinity towards oxygen, forming a protective layer of oxide on the surface when exposed to air. Aluminum visually resembles silver, both in its color and in its great ability to reflect light. It is soft, nonmagnetic, and ductile. Aluminum is a light metal in practical applications.

Chemically, aluminum is a post-transition metal in the boron group; as is common for the group, aluminum forms compounds primarily in the +3 oxidation state. The aluminum cation Al³⁺ is small and highly charged; as such, it has more polarizing power, and bonds formed by aluminum have a more covalent character. The strong affinity of aluminum for oxygen leads to the common occurrence of its oxides in nature.

The present invention presents an aluminum alloy which would destroy the continuity of aluminum hydroxide formed during the reaction between aluminum and a medium, thereby accelerating the reaction between aluminum and the medium. The medium could be aqueous solutions such as fresh water, pond water, lake water, salt water, brine water, produced water or flow back water and their mixture with crude oil etc. In one embodiment, the chemical reaction can be: 2Al+6H₂O→2Al(OH)₃+3H₂ (gas)

By adjusting the proportion of each element in the aluminum alloy, the reaction rate of the aluminum alloy with the medium can be regulated, resulting in a relatively wider controllable range, and the aluminum alloy material is flexible, so that the aluminum alloy meets the application requirements of the industrial sector such as oil and gas industry.

The mechanical properties such as tensile strength and yield strength of aluminum alloy are improved by adding gallium, indium, and bismuth to the aluminum alloy. Tensile strength is the resistance of a material to breakage under tension and it is usually obtained by the stress-strain curve. The unit is usually in MPa or KSI etc. Elongation is the amount of extension of an object under stress upon breakage, usually expressed as a percentage of the original length. In the application in oil and gas industries, such as frac balls, frac plugs or frac seats, not only has the aluminum alloys to be dissolved in a medium, but also the alloys need to have higher mechanical strength to withstand the high pressure and high temperature scenario.

It is desirable to alloy iron, copper, and nickel to the baseline to accelerate corrosion. Nickel, copper, iron, or a combination of the three may be added to achieve a specific dissolution rate by intra-granular or intergranular galvanic corrosion. Copper alone will not have a sufficient corrosion rate for many conditions. Nickel and iron may drop out of the solution if an improper amount is added. Tuning the corrosion rate without a detrimental impact on mechanical properties often requires a combination of two elements in a particular amount.

The present invention disclosure shows the dissolvable aluminum alloy compatible with the conditions associated with downhole operations, such as hydraulic fracturing operations. When the dissolvable aluminum alloy is formed in a component of a downhole tool, the component must have the same functionality as the conventional non-dissolving component. The component must be sufficiently strong to hold a pressure differential around 7.5 ksi as assembled in the downhole tool. There may be other components of the dissolvable aluminum alloy in the downhole tool as well. The component must also dissolve in a wellbore fluid, such as a potassium chloride brine, after the downhole operation is completed. The alloy remains strong, and ductile to be formed into a component and functional as a downhole tool. The dissolvability is controlled within a range for a potassium chloride brine. Additionally, the yield strength, ultimate tensile strength, and elongation of the present invention are sufficient to function as components of a downhole tool, despite the additives in grains of the aluminum affecting overall strength.

In one embodiment, elements of copper, gallium, and indium are used to improve the solubility of various other metal elements. Moreover, copper, nickel, gallium, indium, and silicon in aluminum alloys increase the reaction rate of aluminum alloys with a medium. Other elements in aluminum alloys, such as magnesium, zinc, zirconium, rhenium, iron, beryllium, and calcium, may serve to catalyze the improvement of the mechanical properties of aluminum alloys.

Zirconium forms Al₃Zr dispersoids in the aluminum that have an L1₂ structure in the metastable condition and a DO₂₃ structure in the equilibrium condition. The Al₃Zr dispersoids have a low diffusion coefficient, which makes them thermally stable and highly resistant to coarsening.

The amount of iron present in the alloys of this invention, if any, may vary from about 0 to about 0.5 weight percent. The amount of iron present depends on the solubility of iron in aluminum. Iron has limited solubility in aluminum, but its solubility can be extended significantly by utilizing rapid solidification techniques. The Al—Fe system forms a eutectic with aluminum, resulting in a mixture of Al₃Fe dispersoids in a solid solution of iron in aluminum. Slower cooling rate techniques (i.e., casting) may be used for processing alloys having iron additions. However, rapid solidification techniques may be preferred in some embodiments to increase the supersaturation of iron and decrease the size of the dispersoids, which thereby provides higher strength to the alloy. Rapid solidification techniques can also form a metastable phase of Al₃Fe through a eutectic reaction.

The amount of chromium present in the alloys of this invention, if any, may vary from about 0.18 to about 2.0 weight percent. The amount of chromium present depends on the solubility of chromium in aluminum. Chromium has limited solubility in aluminum, but its solubility can be extended significantly by utilizing rapid solidification techniques. The Al—Or system forms a peritectic reaction with the aluminum, where the reaction of liquid and Al₁₁Cr₂ results in Al₇Cr dispersoids and a solid solution of chromium in aluminum. Slower cooling rate techniques (i.e., casting) may be used for processing alloys having chromium additions. However, rapid solidification techniques may be preferred in some embodiments to increase the supersaturation of chromium and decrease the size of the dispersoids, which thereby provides higher strength to the alloy.

The amount of manganese present in the alloys of this invention, if any, may vary from about 0 to about 0.3% weight percent. The amount of manganese present depends on the solubility of manganese in aluminum. Manganese has limited solubility in aluminum, but its solubility can be extended significantly by utilizing rapid solidification techniques. The Al—Mn system forms a eutectic with aluminum, resulting in Al₆Mn dispersoids in a solid solution of manganese in aluminum. Slower cooling rate techniques (i.e., casting) may be used for processing alloys having manganese additions. However, rapid solidification techniques may be preferred in some embodiments to increase the supersaturation of manganese and decrease the size of the dispersoids, which thereby provides higher strength to the alloy.

In one embodiment, additions of gallium and/or indium are effective for managing corrosion in aluminum or aluminum alloy, and such metals can be added as a coating on the aluminum particles, as intermetallic particles, and/or by adding as a solid solution from an aluminum alloy melt. Additional strengthening phases and solid solution material can be used to accelerate or inhibit corrosion rates. In general, aluminum decreases corrosion rates, while zinc is neutral or can enhance corrosion rates. Corrosion rates of 0.02 mm/hr-5 mm/hr. (and all values and ranges therebetween) at a temperature of 35-200° C. for the composite can be achieved in freshwater or brine environments. More specifically, one embodiment of exemplary embodiment has a dissolving rate in a range of from about 10 to about 100 mg/cm²/hr.

These aluminum alloys may be made in various forms (i.e., ribbon, flake, powder, etc.) by any rapid solidification technique that can provide supersaturation of elements, such as, but not limited to, melt spinning, splat quenching, spray deposition, vacuum plasma spraying, cold spraying, laser melting, mechanical alloying, ball milling (i.e., at room temperature), cryomilling (I.e., in a liquid nitrogen environment), spin forming, or atomization. Any processing technique utilizing cooling rates equivalent to or higher than about 10³° C./second is considered to be a rapid solidification technique for these alloys. Therefore, the minimum desired cooling rate for the processing of these alloys is about 10³° C./second, although higher cooling rates may be necessary for alloys having larger amounts of alloying additions. These aluminum alloys may also be made using various casting processes, such as, for example, squeeze casting, die casting, sand casting, permanent mold casting, etc., provided the alloy contains sufficient alloying additions.

Atomization may be the preferred technique for creating embodiments of these alloys. Atomization is one of the most common rapid solidification techniques used to produce large volumes of powder. The cooling rate experienced during atomization depends on the powder size and usually varies from about 10³ to about 10⁵° C./second. Helium gas atomization is often desirable because helium gas provides higher heat transfer coefficients, which leads to higher cooling rates in the powder. Fine size powders (i.e., about ˜325 mesh) may be desirable to achieve maximum supersaturation of alloying elements that can precipitate out during powder processing.

Cryomilling may be the preferred technique for creating other embodiments of these alloys. Cryomilling introduces oxynitride particles in the powder that can provide additional strengthening to the alloy at high temperatures by increasing the threshold stress for dislocation climb. Additionally, the nitride particles, when located on grain boundaries, can reduce the grain boundary sliding in the alloy by pinning the dislocation, which results in reduced dislocation mobility in the grain boundary.

Once the alloy composition (i.e., ribbon, flake, powder, etc.) is created, and after suitable vacuum degassing, the powder, ribbon, flake, etc. can be compacted in any suitable manner, such as, for example, by vacuum hot pressing or blind die compaction (where compaction occurs in both by shear deformation) or by hot isostatic pressing (where compaction occurs by diffusional creep).

After compaction, the alloy may be extruded, forged, or rolled to impart deformation thereto, which is important for achieving the best mechanical properties in the alloy. In embodiments, extrusion ratios ranging from about 10:1 to about 22:1 may be desired. In some embodiments, low extrusion ratios (i.e., about 2:1 to about 9:1) may be useful. Hot vacuum degassing, vacuum hot pressing, and extrusion may be carried out at any suitable temperature, such as, for example, at about 572-842° F. (300-450° C.). Various embodiments of the following novel alloy compositions (in weight percent) were produced using various powder metallurgy processes: about 0.49 wt % Ga, 0.45 wt % In, 2.2 wt % Ce, and the balance of 7075 aluminum (96.6 wt %); about 1 wt % Ga, 1 wt % In, 2.45 wt % Ce, and the balance of 7075 aluminum (95.55 wt %); about 0.8 wt % Ga, 0.8 wt % In, and the balance of 7075 aluminum (98.40%), as shown below Table 1.

TABLE 1
Composition of various alloys (note: 7075 aluminum contains
87.1-91.4% aluminum, 5.1-6.1% zinc, 1.2-2.0% copper,
0.0-0.3% manganese, 0.0-0.4% silicon, 0.0-0.5% iron,
2.1-2.9% magnesium, 0.18-2.0% chromium, 0.0-0.2% titanium,
and 0.05-0.15% of other elements, for example).

| Alloy | Composition |
|---|---|
| Alloy | 0.49 wt % Ga, 0.45 wt % In, 2.2 wt % Ce, and the balance of |
| HSAL #1 | 7075 aluminum (96.6 wt %) |
| Alloy | 1 wt % Ga, 1 wt % In, 2.45 wt % Ce, and the balance of 7075 |
| HSAL #2 | aluminum (95.55 wt %) |
| HTAL #1 | 0.8 wt % Ga, 0.8 wt % In, and the balance of 7075 aluminum |
| | (98.40%) |

The powder metallurgy processes used for producing these alloys consisted of ingot fabrication, inert helium gas atomization, hot vacuum degassing, vacuum hot pressing, and extrusion. Alloying elements were mixed and melted in an argon atmosphere at about 2100-2300° F. (1149-1260° C.) for about 15-60 minutes to form ingots of the above-noted compositions, each having very low oxygen content. The ingots were then further melted in an argon atmosphere at about 2400-2600° F. (1316°-1427° C.) for about 15-60 minutes, and were then atomized via helium gas atomization to form spherical powders that also had very low oxygen content. The powders were then sieved to about-325 mesh. Thereafter, the powders were hot vacuum degassed at about 650°-750° F. (343-399° C.) for about 4-15 hours to remove moisture and undesired gases from the powders. Next, the powders were compacted in a unidirectional vacuum hot press at about 650-750° F. (343-399° C.) for about 1-5 hours to create billets. The billets were then extruded at about 650-750° F. (343-399° C.) for about 5-30 minutes using extrusion ratios ranging from about 5:1 to about 25:1 to produce round bars of different sizes.

Various properties (i.e., ultimate tensile strength, yield strength, percent elongation, percent reduction in area, and modulus) of these round bars or other configurations were then tested in air. These same properties were also tested at high temperatures (i.e., about 140° C.).

The alloys of the present application can be used in monolithic form or can contain continuous or discontinuous reinforcement materials (i.e., second phases) to produce metal-matrix composites. Suitable reinforcement materials include, but are not limited to, oxides, carbides, nitrides, oxynitrides, oxycarbonitrides, silicides, borides, boron, graphite, ferrous alloys, tungsten, titanium and/or mixtures thereof. Specific reinforcement materials include, but are not limited to, SiC, Si₃N₄, Al₂O₃, BAC, Y₂O₃, MgAl₂O₄, TiC, TiB₂ and/or mixtures thereof. These reinforcement materials may be present in volume fractions of up to about 50 volume percent, more preferably about 0.5-50 volume percent, and even more preferably about 0.5-20 volume percent, for example.

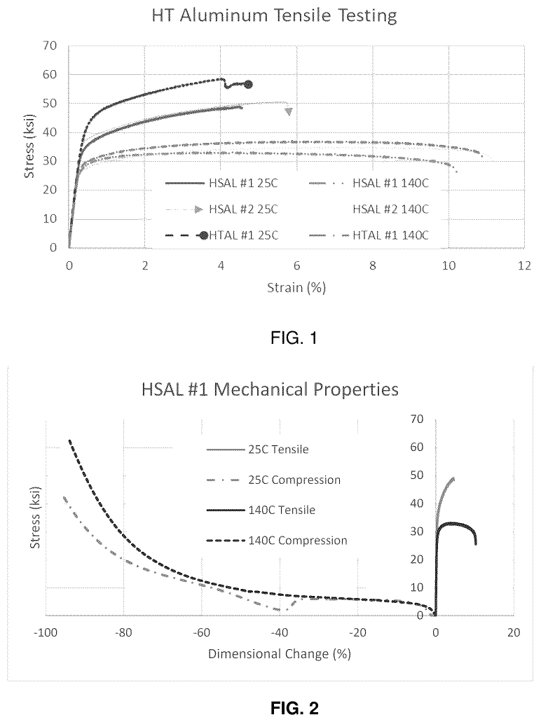

As shown in FIG. 1, extruded tensile testing results for the three alloys at room temperature and 140 C. Alloy HTAL #1 shows the highest yield of 43 KSI at room temperature. HSAL #2 shows a yield of 38 KSI at room temperature. Alloy HSAL #1 shows the lowest yield of 33.0 KSI at room temperature. A yield of 33 ksi and UTS of 48.9 ksi are paired with an elongation of 4.6% for alloy HSAL #1 at room temperature (25° C.). For alloy HSAL #2, a yield of 38 ksi and UTS of 50.7 ksi are paired with an elongation of 5.8% for at room temperature (25° C.). A yield of 43 ksi and ultimate tensile strength (UTS) of 58.5 ksi are paired with an elongation of 4.7% for alloy HTAL #1 at room temperature (25° C.).

At 140° C., alloy HTAL #1 shows the highest yield of 29 KSI. HSAL #1 shows a yield of 28 KSI at 100° C. Alloy HSAL #2 shows the lowest yield of 27.0 KSI at 140° C. A yield of 28 ksi and UTS of 33 ksi are paired with an elongation of 10.2% for alloy HSAL #1 at 140° C. For alloy HSAL #2, a yield of 27 ksi and UTS of 35.1 ksi are paired with an elongation of 11.2% at 140° C. A yield of 29 ksi and UTS of 37.1 ksi are paired with an elongation of 10.9% for alloy HTAL #1 at 140° C.

As shown in the FIG. 1 and below Table 2, with the increase of the temperature, yields and UTS for all three alloys decrease. However, with the increase of the temperature, elongation has increased for all alloys.

TABLE 2

| | | HSAL | HSAL | HTAL |
|---|---|---|---|---|
| | | #1 | #2 | #1 |
| 25° C. | Yield (ksi) | 33.0 | 38.0 | 43.0 |
| | UTS (ksi) | 48.9 | 50.7 | 58.5 |
| | Elongation | 4.6 | 5.8 | 4.7 |
| | (%) | | | |
| 140° C. | Yield (ksi) | 28.0 | 27.0 | 29.0 |
| | UTS (ksi) | 33.0 | 35.1 | 37.1 |
| | Elongation | 10.2 | 11.2 | 10.9 |
| | (%) | | | |

The FIG. 2 shows mechanical properties in terms of dimensional change and stress for alloy HSAL #1. The stress increases when the alloy HSAL #1 is compressed at 25° C. and 140° C. Similarly, the stress increases much faster when the alloy is stretched before it is broken. More specifically, a yield of 3.5 ksi and ultimate compression strength (UCS) of 42.2 ksi are paired with an elongation of 95% for alloy HSAL #1 at room temperature (25° C.). A yield of 3 ksi and ultimate compression strength (UCS) of 62.8 ksi are paired with an elongation of 95% for alloy HSAL #1 at 140° C.

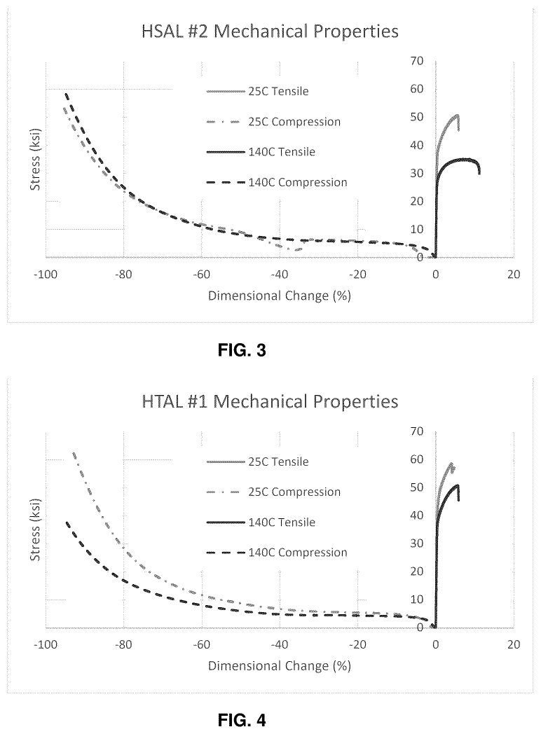

The FIG. 3 shows mechanical properties in terms of dimensional change and stress for alloy HSAL #2. The stress increases when the alloy HSAL #2 is compressed at 25° C. and 140° C. Similarly, the stress increases much faster when the alloy is stretched before it is broke. More specifically, a yield of 4 ksi and ultimate compression strength (UCS) of 53.3 ksi are paired with an elongation of 95% for alloy HSAL #2 at room temperature (25° C.). A yield of 3 ksi and ultimate compression strength (UCS) of 59.9 ksi are paired with an elongation of 95% for alloy HSAL #2 at 140° C.

The FIG. 4 shows mechanical properties in terms of dimensional change and stress for alloy HTAL #1. The stress increases when the alloy HTAL #1 is compressed at 25 C and 140 C. Similarly, the stress increases much faster when the alloy is stretched before it is broken. More specifically, a yield of 3.5 ksi and ultimate compression strength (UCS) of 62.8 ksi are paired with an elongation of 95% for alloy HTAL #1 at room temperature (25° C.). A yield of 3 ksi and ultimate compression strength (UCS) of 39.1 ksi are paired with an elongation of 95% for alloy HTAL #1 at 140° C.

From FIGS. 2-4, we can conclude that the ultimate compression strength ranges from about 42 to about 63 ksi for room temperature for three alloys, and about 39 to about 62.8 ksi at 140° C. The graph shows that this will work very well in compressive applications, such as a metal seal on a dissolvable frac plug, where 1) high deformation via compression without cracking and 2) serialized temperature functionality (do not dissolve below a certain temperature).

TABLE 3

| | | HSAL | HSAL | HTAL |
|---|---|---|---|---|
| | | #1 | #2 | #1 |
| 25° C. | Yield (ksi) | 3.5 | 4 | 3.5 |
| | UCS (ksi) | 42.2 | 53.3 | 62.8 |
| | Compression | >95% | >95% | >95% |
| | (%) | | | |
| 140° C. | Yield (ksi) | 3 | 3 | 3 |
| | UCS (ksi) | 62.8 | 59.9 | 39.1 |
| | Compression | >95% | >95% | >95% |
| | (%) | | | |

A downhole tool for use in a cased well, the downhole tool may comprise a plug, split rings for seal or pack off, a backup pump out ring, an interchangeable parts kit, a degradable aluminum seal or pack off, and other features and methods; all applicable to a substantially all-aluminum downhole tool.

The disclosed plug dissolves in conjunction with natural wellbore fluid, or operator added fluid, namely an aluminum dissolving or melting medium. In one embodiment, natural wellbore fluids produced from the formation flow through the plug's aluminum mandrel and about its other aluminum parts and, over a predetermined duration of time, dependent on plug composition, fluid composition, temperature, pH and the like, substantially dissolve the plug's mandrel and other aluminum parts. As the mandrel and other parts dissolve, fluid reaches the remainder of the plug and begins to dissolve the remainder of the plug. The plug dissolves substantially completely. “Dissolve” as used herein means for a unit to dissolve, oxidize, reduce, deteriorate, go into solution, or otherwise lose sufficient mass and structural integrity due to being in contact with fluid from or in the well that the dissolved unit ceases to obstruct the wellbore. This removes the necessity for drilling out or removing the plug from the well so completion can continue.

In one embodiment, balancing the cost of rig time on site while waiting for the plug to dissolve against the cost of milling out the plug without delay, the practical period of time for the plug to dissolve is between a few hours and two days. If, for a particular well, additional well completion work below the plug is unnecessary for an extended period of time, then the time for dissolution of the plug which is practical for that well may be increased to that extended period of time ranging from about three to five days to about three months. A useful wellbore fluid is preferably acidic, having a pH less than 7. Greater acidity speeds dissolution of the disclosed plugs. A more preferable has a pH less than 5, or a range of pH from about 4-5. The preferable duration for the plug to dissolve in the well is determined before choosing to use the plug in the well and is used in choosing which dissolvable plug with which structures and materials to employ. In one embodiment, it is about two to three hours to about two to five days from setting, or up to three to five weeks. After the plug is placed in the well and used, the next step of well completion is delayed until expiration of the determined duration for plug dissolution, that is, the time between immersing the plug in the wellbore fluid and the plug's ceasing to prevent the next step of well completion due to the plug dissolving. Alternatively, if operator added fluid used to cause or accelerate plug dissolution, the next step of well completion is delayed until expiration of the determined duration for plug duration after the operator added fluid is added.

The strength of an alloy is contingent upon the ease with which dislocations move. Opposing dislocation motion increases mechanical strength. The addition of rare earth acts as a grain refiner in aluminum, as smaller grains hinder dislocation motion. Dislocations may be pinned due to stress field interactions with other dislocations and solute particles, creating physical barriers from second phase precipitates forming along grain boundaries. Further, rare earth depresses the corrosion rate. It is expected that corrosion will decrease significantly; the elongation would be similar, with a modest increase in yield and UTS.

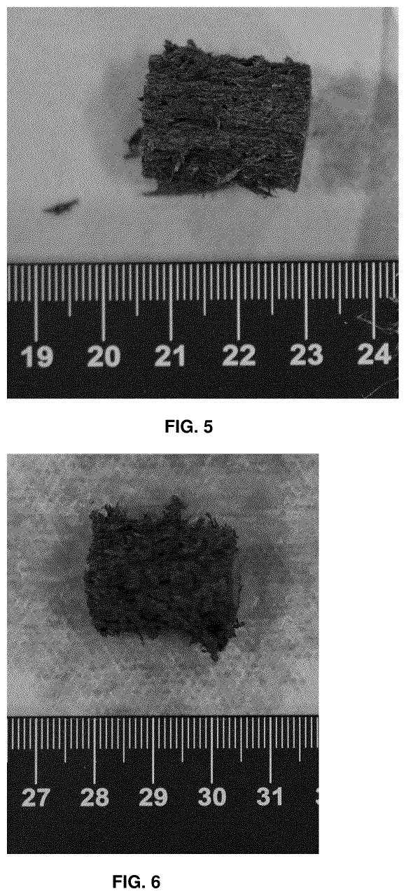

As shown in FIG. 5, the alloy HSAL #1 did not experience dissolution at 95° C., however, it corroded with an increase in temperature and would be useful in the applications at this temperature of 120° C. 2.1% KCl solution.

As shown in FIG. 6, the alloy HSAL #2 did not experience dissolution at 95° C., however, it corroded with an increase in temperature and would be useful in the applications at this temperature of 120° C. 2.1% KCl solution.

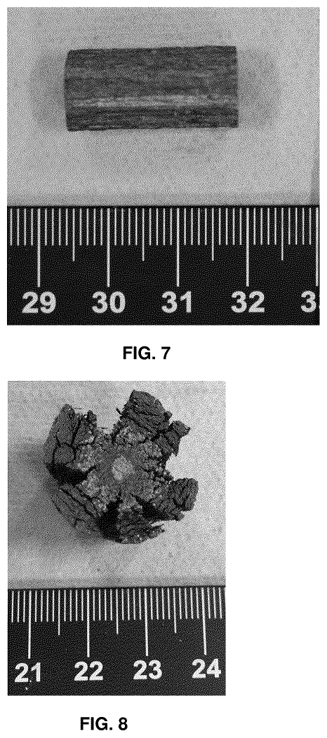

FIG. 7 shows that alloy HTAL #1 did not experience dissolution at 120° C. 2.1% KCL solution, which means that HTAL #1 would not be useful at this temperature.

FIG. 8 shows that alloy HTAL #1 did not experience dissolution at 120° C., however, it corroded with an increase in temperature and would be useful in the application at 150° C. 2.1% KCL solution.

In one embodiment, an alloy having <1.5 weight % gallium, <1.5 weight % indium, and <1.5 weight % bismuth which was uniquely found to only initiate dissolution around 140° C. regardless of salinity. No other material in literature possessed this feature. Other dissolvable aluminum alloys, regardless of formulation, would either dissolve too quickly for high temperature or not at all.

In another embodiment, despite this advancement, the mechanical properties experienced a precipitous decline at elevated temperatures. The alloy family might find use in a low yield high elongation application, but lacks sufficient strength for structural applications.

In further another embodiment, a chemistry in the range of <1.5 weight % gallium, <1.5 weight % indium, <1.5 weight % bismuth and <5 weight % cerium was observed to retain sufficient mechanical properties at elevated temperature to be used in structural applications, such as a dissolvable plug mandrel or cone. The amount of gallium, indium, and bismuth may be balanced to engineer the temperature at which dissolution commences, and the rate at which the material dissolves, depending on the well conditions. Cerium may be substituted for any number of rare earth elements such as gadolinium, for example, to achieve similar results.

The dissolvable aluminum alloys are targeted for high temperature (>125° C.) oil and gas applications, particularly dissolvable fracture plugs. The potential use for a seal in an all metal plug is a unique feature. The high temperature stability is a unique feature of these aluminum alloys. The tailorable temperature range activation is another unique feature of this alloy series. The most important feature is the elimination of stress corrosion cracking. Numerous tests demonstrate magnesium is susceptible, but aluminum is not. This is a clear advantage over other existing alloys for high temperature dissolvable plugs.

Adding cerium lowered the dissolution activation temperature threshold. It was assumed the cerium containing alloys (HSAL #1 and #2) would not dissolve at a lower temperature than the alloy lacking cerium (HTAL #1). This is contrary to expectations of one skilled in the art, as rare earth is perceived to increase corrosion resistance.

### Example 1

In one embodiment, aluminum alloy of the present invention comprises 0.49 wt % Ga, 0.45 wt % In, 2.2 wt % Ce, and the balance of 7075 (96.6 wt %). In one embodiment, the production process is as follows:

Weighing raw materials such as 7075 aluminum, gallium, indium, cerium, and pretreating 7075 aluminum, gallium, indium, cerium, at 600° C. for 5 h; mixing the raw materials, and then smelting them in a crucible electric resistance furnace, covering them with a covering agent, and refining them with a refining agent, thus the components are uniformly mixed, removing the inclusions, and casting the materials at 670° C. to form an ingot; subjecting the ingot to a homogenization heat treatment at 450° C. for a treatment time of 8 h; subjecting the ingot to a forging processing at 350° C. so as to obtain a forged piece; subjecting the forged piece to an extrusion process at exit temperature about 300° C.; subjecting the extruded piece to an aging heat treatment at room temperature for a treatment time of 20 h.

### Example 2

In one embodiment, aluminum alloy of the present invention comprises 1 wt % Ga, 1 wt % In, 2.45 wt % Ce, and the balance of 7075 (95.55 wt %). In one embodiment, the production process is as follows:

Weighing raw materials such as 7075 aluminum, gallium, indium, cerium, and pretreating 7075 aluminum, gallium, indium, cerium, at 600° C. for 5 h; mixing the raw materials, and then smelting them in a crucible electric resistance furnace, covering them with a covering agent, and refining them with a refining agent, thus the components are uniformly mixed, removing the inclusions, and casting the materials at 670° C. to form an ingot; subjecting the ingot to a homogenization heat treatment at 450° C. for a treatment time of 8 h; subjecting the forged piece to an extrusion process at exit temperature about 300° C.; subjecting the extruded piece to an aging heat treatment at room temperature for a treatment time of 20 h.

### Example 3

In one embodiment, aluminum alloy of the present invention comprises 0.8 wt % Ga, 0.8 wt % In, and the balance of 7075 (98.40 wt %). In one embodiment, the production process is as follows:

Weighing raw materials such as 7075 aluminum, gallium, indium, and pretreating 7075 aluminum, gallium, indium, at 600° C. for 5 h; mixing the raw materials, and then smelting them in a crucible electric resistance furnace, covering them with a covering agent, and refining them with a refining agent, thus the components are uniformly mixed, removing the inclusions, and casting the materials at 670° C. to form an ingot; subjecting the ingot to a homogenization heat treatment at 450° C. for a treatment time of 8 h; subjecting the forged piece to an extrusion process at exit temperature about 300° C.; subjecting the extruded piece to an aging heat treatment at room temperature for a treatment time of 20 h.

### Example 4

In one embodiment, aluminum alloy of the present invention comprises 1 wt % Ga, 1 wt % In, 1.1 wt % Bi, and the balance of 7075 (96.90 wt %). In one embodiment, the production process is as follows:

Weighing raw materials such as 7075 aluminum, gallium, indium, bismuth, and pretreating 7075 aluminum, gallium, indium, bismuth, at 600° C. for 5 h; mixing the raw materials, and then smelting them in a crucible electric resistance furnace, covering them with a covering agent, and refining them with a refining agent, thus the components are uniformly mixed, removing the inclusions, and casting the materials at 670° C. to form an ingot; subjecting the ingot to a homogenization heat treatment at 450° C. for a treatment time of 8 h; subjecting the forged piece to an extrusion process at exit temperature about 300° C.; subjecting the extruded piece to an aging heat treatment at room temperature for a treatment time of 20 h.

The foregoing disclosure and description of the invention is illustrative and explanatory thereof. Various changes in the details of the illustrated structures, construction and method can be made without departing from the true spirit of the invention.

We claim:

1. A dissolvable alloy for a component of a downhole tool, comprising:
from about 0.01 wt % to about 1.5 wt % gallium;
from about 0.01 wt % to about 1.5 wt % indium;
from about 0.01 wt % to about 1.5 wt % bismuth; and
the balance of substantial aluminum so as to be dissolvable in KCl at about 2.1% by weight and about 93° C. with a dissolving rate in a range of from about 10 to about 100 mg/cm²/hr, yield strength in a range of from about 25 to about 45 ksi, ultimate tensile strength in a range of from about 35 to about 60 ksi, and elongation in a range of from about 4 to about 15% at room temperature.

2. The dissolvable alloy of claim 1 further comprising from about 5.1 wt % to about 6.1 wt % zinc.

3. The dissolvable alloy of claim 2, further comprising from about 1.2 wt % to about 2.0 wt % copper.

4. The dissolvable alloy of claim 3, further comprising from about 2.1 wt % to about 2.9 wt % magnesium.

5. The dissolvable alloy of claim 4, further comprising from about 0.18 wt % to about 2.0 wt % chromium.

6. The dissolvable alloy of claim 5, further comprising from about 0.0 to about 0.2 wt % titanium.

7. The dissolvable alloy of claim 6, further comprising from about 0.0 to about 0.4% silicon.

8. The dissolvable alloy of claim 7, further comprising from about 0.0 to about 0.5% iron.

9. The dissolvable alloy of claim 1, further comprising from about 0.01 wt % to about 5.0 wt % cerium.

10. A dissolvable alloy for a component of a downhole tool, comprising:
from about 0.01 wt % to about 1.5 wt % gallium;
from about 5.1 wt % to about 6.1 wt % zinc;
from about 1.2 wt % to about 2.0 wt % copper; and
the balance of substantial aluminum so as to be dissolvable in KCl at about 2.1% by weight and about 93° C. with a dissolving rate in a range of from about 10 to about 100 mg/cm²/hr, yield strength in a range of from about 25 to about 45 ksi, ultimate tensile strength in a range of from about 35 to about 60 ksi, and elongation in a range of from about 4 to about 15% at room temperature.

11. The alloy of claim 10, further comprising from about 0.01 wt % to about 1.5 wt % indium.

12. The alloy of claim 11, further comprising from about 0.01 wt % to about 1.5 wt % bismuth.

13. The alloy of claim 12, further comprising from about 2.1 wt % to about 2.9 wt % magnesium.

14. The alloy of claim 13, further comprising from about 0.0 to about 0.2 wt % titanium.

15. The alloy of claim 14, further comprising from about 0.01 wt % to about 5.0 wt % cerium.

16. A dissolvable alloy for a component of a downhole tool, comprising:
from about 0.01 wt % to about 1.5 wt % indium;
from about 0.01 wt % to about 1.5 wt % bismuth;
from about 5.1 wt % to about 6.1 wt % zinc; and
the balance of substantial aluminum so as to be dissolvable in KCl at about 2.1% by weight and about 93° C. with a dissolving rate in a range of from about 10 to about 100 mg/cm²/hr, yield strength in a range of from about 25 to about 45 ksi, ultimate tensile strength in a range of from about 35 to about 60 ksi, and elongation in a range of from about 4 to about 15% at room temperature.

17. The dissolvable alloy of claim 16, further comprising from about 1.2 wt % to about 2.0 wt % copper.

18. The dissolvable alloy of claim 17, further comprising from about 2.1 wt % to about 2.9 wt % magnesium.

19. The dissolvable alloy of claim 18, further comprising from about 0.18 wt % to about 2.0 wt % chromium.

20. The dissolvable alloy of claim 19, further comprising from about 0.01 wt % to about 5.0 wt % cerium.
